(19) United States
(12) Patent Application Publication
(10) Pub. No.: US 2010/0121722 A1
(43) Pub. Date: May 13, 2010

(54) SYSTEM AND METHOD FOR AUTOMATING CONSUMER FOOD ORDERS

(76) Inventor: JAMISON VAWTER, Freehold, NJ (US)

Correspondence Address: VALDIVIA-LAFEIR LAW, 12 GLEN OAK DRIVE, MIDDLETOWN, NJ, 07748, US

(21) Appl. No.: 12/553,981

(22) Filed: Sep. 3, 2009

Related U.S. Application Data
(60) Provisional application No. 61/094,051, filed on Sep. 3, 2008.

(51) Int. Cl. G06Q 50/00; G06F 17/30

(52) U.S. Cl. 705/15; 707/705; 707/E17.107

(57) ABSTRACT

A system and method are provided for automating consumer restaurant and grocery food orders, and more specifically, a system for compiling a food order for a specific food establishment utilizing the consumer's food interests and the establishment's available food menu. The system includes a software application for generating a consumer account comprising food preferences, either entered by the consumer manually or by automatically collecting history data from one or more food establishments. Such data is then used to generate individual food orders for a specific customer at each food establishment. The system can further include a customer identification card which can be used at each food establishment to automatically draw up an order. Alternately, orders may be automatically created at specific times during a day based on data sent to an establishment from an application repository on an automated basis.

### CROSS-REFERENCE TO OTHER APPLICATIONS

This application claims the benefit of U.S. Provisional Application No. 61/094,051, entitled “System and Method for Automatic Restaurant Food Orders,” filed on Sep. 3, 2008, which is hereby incorporated by reference.

### BACKGROUND OF THE INVENTION

1. Field of the Invention

This invention relates to a system and method for automating consumer restaurant and grocery food orders, and more specifically, a system for compiling a food order for a specific food establishment utilizing the consumer's food interests and the establishment's available food menu.

2. Description of Prior Art

Currently, consumers can configure daily food plans and/or diet plans for themselves using dietary websites, for example, www.ediets.com, weight planning companies, for example, Weight Watchers®, and advertisements for healthy food from quick-service restaurants (“QSR”) such as McDonalds®, Wendy's®, and the like.

Drawbacks associated with these programs include difficulty effectively marketing healthy meal choices to a consumer to select a dietary goal (e.g. calories, fat, sodium, carbohydrates) and automatically generating a food order to meet the stated consumer's health goals.

### SUMMARY

A solution is presented by a system and method for automating consumer food and/or grocery orders from one or more food establishments by integrating the consumer's food interests and desires with available food items presented from a specific food establishment, for example a QSR.

According to embodiments of the present invention, a system and method include a software application for generating a consumer account, stored in an electronic database, comprising food preferences, including food likes, dislikes, any associated food allergies, specific selections from one or more particular food establishments, and the like. This account may be generated automatically by collecting history data from one or more food establishments. Alternately, the account may be generated manually via a consumer accessing the software application, either directly on a personal computer, through a cellular telephone, or online through an Internet connection.

The consumer account may also be linked to one or more payment sources, and to a mobile phone number to provide mobile phone ordering. The system includes one or more unique identification cards associated with the consumer and the consumer's account. The identification card may include features such as a magnetic stripe, a radio frequency identification component, a unique barcode, and the like.

Food orders at one or more selected establishments are automatically generated by the system based on the consumer's account details and are transmitted to the establishments, either at pre-specified times during a particular day, when a consumer uses his or her identification card at the establishments, or when a consumer sends in an order electronically, for example, through his or her cellular phone. The selected establishment prepares the order, and once purchased, transmits the order back to the system. The system then may update the consumer's account if changes were made to the order.

Other and further properties and details of the present invention will become apparent during the course of the following discussion and by reference to the accompanying drawings.

### BRIEF DESCRIPTION OF THE FIGURES

Referring now to the drawings,

FIG. 1 shows a process flow for a method for creating a food order using the inventive system, according to an embodiment of the present invention;

FIG. 2 shows a process flow for an alternative method similar to that shown in FIG. 1, according to an embodiment of the present invention; and

FIGS. 3 and 4 display graphic user interfaces associated with the software application from the inventive system, according to an embodiment of the present invention.

### DETAILED DESCRIPTION OF THE INVENTION

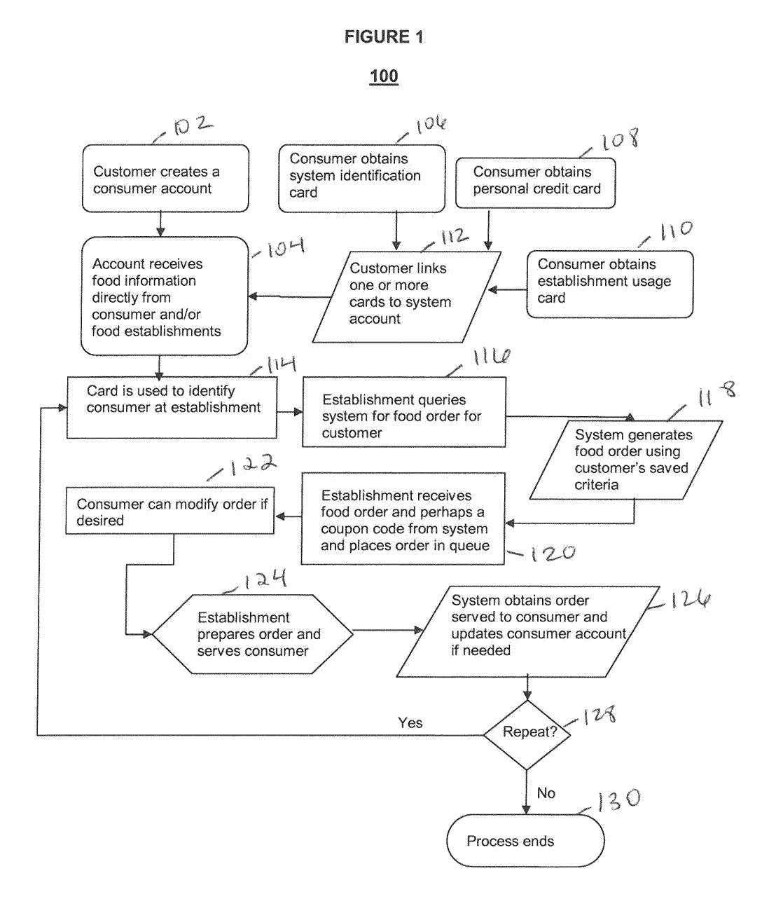

According to an embodiment of the present invention, a system includes an electronic database comprising at least one consumer account, a software application communicatively connected to the database, where the application transmits and receives consumer information and establishment information, and communicative connections to one or more computers or other electronic devices, both at consumers' residences and at food establishments. A method for using the system is shown in FIG. 1.

In method 100, a consumer accesses the inventive software application and creates or opens a consumer account in step 102. The consumer then enters individual data into the account in step 104, including general and specific food likes and dislikes, allergies, weight loss programs, weight goals, ideal caloric intakes, preferred food establishments, such as QSRs and grocery stores, and specific selections from menus of food establishments, in step 104. The consumer may also create and save preferred meals from specific establishments, where such meals would typically be ordered at specific times of a day, or on a certain day.

Additionally, step 104 includes the consumer account automatically receiving data from one or more food establishments based on the consumer's food orders received at such places, either on a periodic or real-time basis.

The consumer may also obtain a unique system identification card in step 106, a personal credit or debit card in step 108, and/or a specific food establishment card in step 110, for example, a DunkinDonuts® card, where such a card is unique to a specific establishment and when used, provides the consumer with special offers at that restaurant. In step 112, the customer can link any and all of the cards identified in steps 106, 108, and 110 to the consumer account created in steps 102 and 104. Optionally, special offers from one or more pre-selected restaurants may be automatically transmitted to the consumer's account from the restaurant in order for the consumer to take advantage of them. Further, linking a consumer charge card to the consumer account in step 108 can allow for automatic payment to be set up between the account and one or more establishments.

At a food establishment, the consumer uses the unique identification card to initially identify the consumer to the establishment, as shown in step 114. Alternately, the consumer may use his or her personal charge card, the specific establishment card, or any other identification card that has been linked to the consumer account generated in steps 102 and 104. The establishment then queries the system for the consumer's account in step 116.

The system transmits account information to the establishment in order for the establishment to prepare a food order for the consumer without the consumer having to verbalize the order, as shown in step 118. The system may perform step 118 by directly transmitting the food order to a computer at the establishment based on the consumer's identified food interests and selections and on the available menu items from the establishment. Alternately, the system may send order detail to the establishment by other means such as a facsimile, a short message service (for example, a text message), and/or electronic mail. Once received, the order is placed into the establishment's order queue in step 120. The consumer and/or an establishment employee can modify the food order before being finalized, in step 122. Once finalized, the order is then fulfilled in step 124, and the order detail or receipt data is transmitted back to the system and to the consumer's account for historical purposes, in step 126. If the final order was altered from the original order submitted from the system, the application will update the consumer's account to reflect such changes and may modify the consumer's preferred choices.

Step 128 allows for the method to repeat at step 114 if the consumer then visits another establishment, or chooses to place a second order at the establishment. Otherwise, the process ends at step 130.

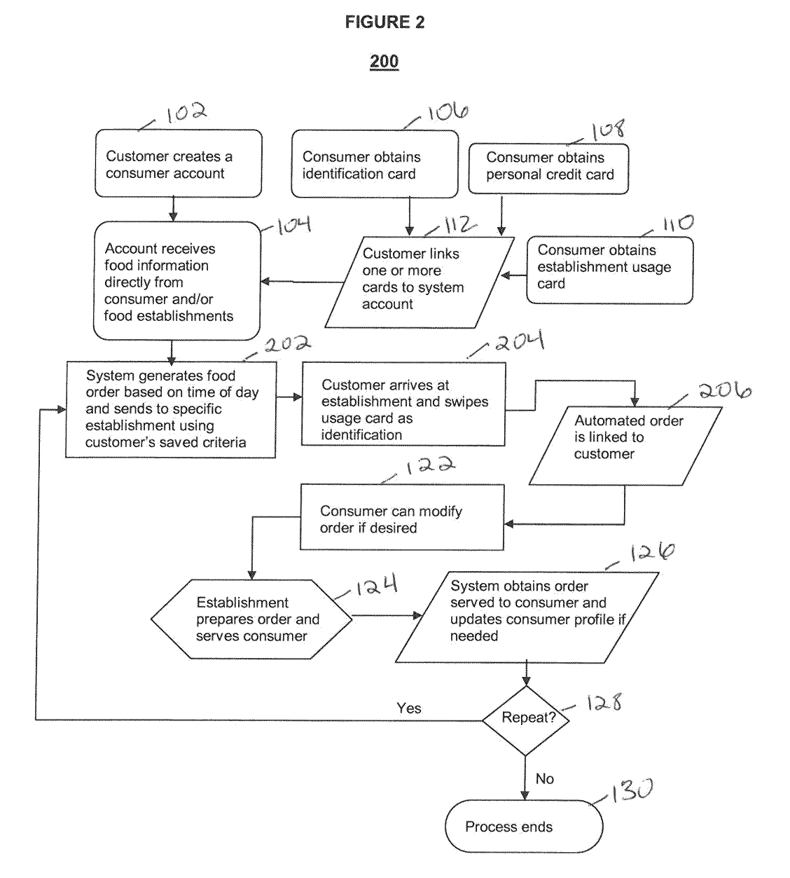

An alternative method 200 for using the inventive system of FIG. 1 is shown in FIG. 2. While most of the steps are the same, this method describes the system sending a generated food pre-order to a food establishment prior to the consumer arriving at an establishment and identifying his or herself, in step 202. Such a pre-order would be created based on the consumer selecting options in his or her consumer account that identify certain food and drink choices are typically bought from a specific establishment at a specific time on one or more days. For example, a consumer who generally stops at a coffee house on the way to work, can generate a breakfast meal for every Monday, that consists of specific food and drink items, that should be ready for pick up by a certain time of the day. Thus, every Monday morning, the consumer can arrive at the coffee house with his or her order ready, and optionally paid for.

Once the system sends the pre-order in step 202, the consumer arrives at the selected establishment and identifies his or herself using the identification card in step 204. The pre-order is then linked to the consumer in step 206 and the consumer can either accept the pre-order or make changes in step 208. The establishment prepares the order and provides it to the consumer in step 122 and the remaining steps in the method proceed according to FIG. 1. Optionally, the establishment may go ahead and prepare the pre-order before the consumer arrives, but takes the risk of the consumer modifying the order. An aspect of this method 200 includes the system pre-charging the consumer for the pre-order and the consumer modifying payment at the establishment based on changes to the order, coupons, etc.

Advantages of the inventive system includes augmenting a verbal order process with an electronic ordering method. This feature can enhance the effectiveness of a drive-thru speaker and microphone used at a quick-service restaurant. The feature may also provide a particular benefit to consumers with special needs, for example, hearing or speech impaired consumers, autistic consumers, and the like.

The system can also automatically adjust a consumer's specific food plan according to the consumer's order history at a specific food establishment to meet stated goals. Additionally, the system can also promote specific food items from a specific establishment that meet specific dietary goals of customers. Further, the system can actively adjust future meal orders according to previous meals in order to meet previously stated consumer goals.

Another advantage of this system includes preventing incorrect food orders produced even when the consumer always places a particular order, but the order taker interprets differently. For example, a consumer orders coffee with no sugar, but the order taker only hears “sugar” and sweetens the coffee by mistake. Using the present system, the consumer can select specific sweetener and creamer types and amounts, thereby substantially eliminating a misinterpretation by the order taker.

Additionally, food establishments frequented by the consumer can become aware of what potential consumers would like to order before food orders are queried for learning what their markets should be. For example, a new “Triple Bacon Cheeseburger” item with limited availability appears in 30% of consumer food orders within a specific region, so establishment decides to carry that new item. Other benefits of the system include improved order accuracy, speeding up the ordering process, substantially removing any language barriers, reducing employee labor, expanding services to hearing-impaired consumers, providing a cost savings on credit card transaction fees by encouraging use of prepaid identification cards, including establishment-specific loyalty cards, and improving customer satisfaction by creating a personal relationship between the consumer and the establishment.

The inventive system application can allow for a consumer to provide feedback on a specific meal order and/or a specific establishment, where such feedback is provided to the establishment. For example, a drive-thru consumer who received an incorrect item can make a comment using a system-provided website or mobile phone. This provides the establishment an opportunity to rectify the problem by providing a credit, coupon or offer to the consumer. Such feedback can also help an establishment identify potential problem employees or processes. Optionally, the system can provide an option to apply a tip of specific amount or percentage on a prepaid order.

Such a system also allows establishment employees to know the unique food preferences of a consumer even if employee's first day on the job.

Other additional system features can include:
Managing a consumer diet plan
   i. Consumer selects dietary goals (e.g. 2,000 cal/day, 80 g fat).
   ii. The system generates a particular number of meals per day using the visited establishment's menu items to meet stated dietary goals.
System-provided Life Coach
   i. Keeps consumer on target for diet.
   ii. Auto-adjusts future meal orders. For example, a consumer modified his suggested Tuesday dietary lunch to a larger food order, so the system changes the previously selected Wednesday lunch a smaller meal.
Managing a consumer exercise plan
   i. Integrates with a Diet Planner application to allow consumer a single source to track a caloric intake and output.
Providing an interactive house pantry
   i. Home Cooked Meal Suggestions
      1. Grocery receipts populate inventory.
      2. Recipes suggested based on current pantry inventory.
   ii. Party Mixer
      1. Liquor purchases populate inventory.
      2. Mixed drinks suggested based on current inventory.
   iii. Shopping Lists
      1. Populated with items from recipes previously selected.
      2. Automatically generated as pantry items are depleted.

Such a system in this embodiment can provide for an establishment to record and maintain data regarding establishment efficiency. Such reports may include current items in consumer food queues, items in consumer food queues that were ordered but unfulfilled or out of stock, and items or meal orders associated with negative or positive comments. Correlation of positive or negative comments with establishment location and specific meal times can be used to enhance employee performance.

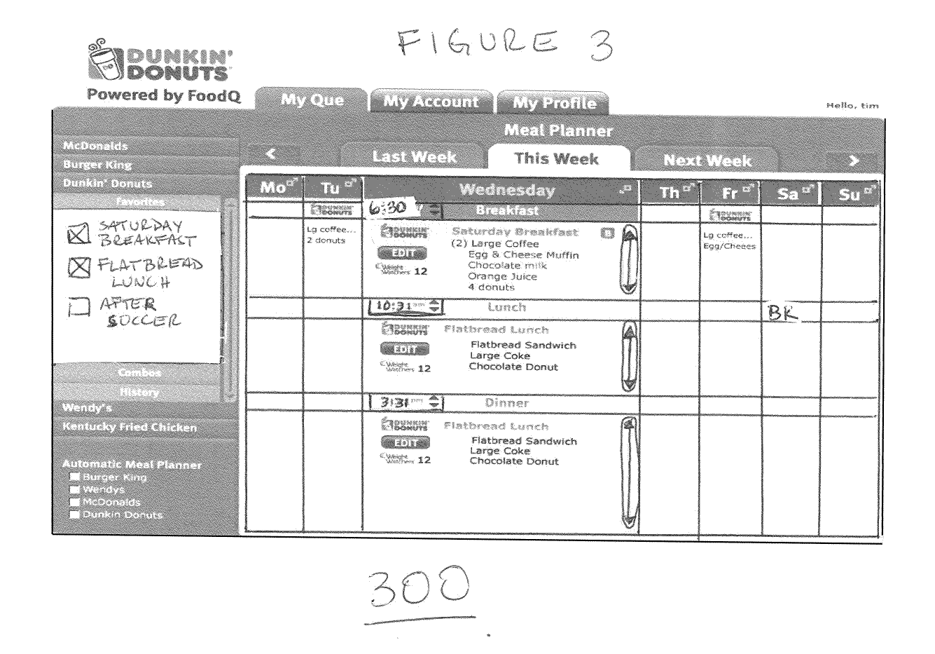

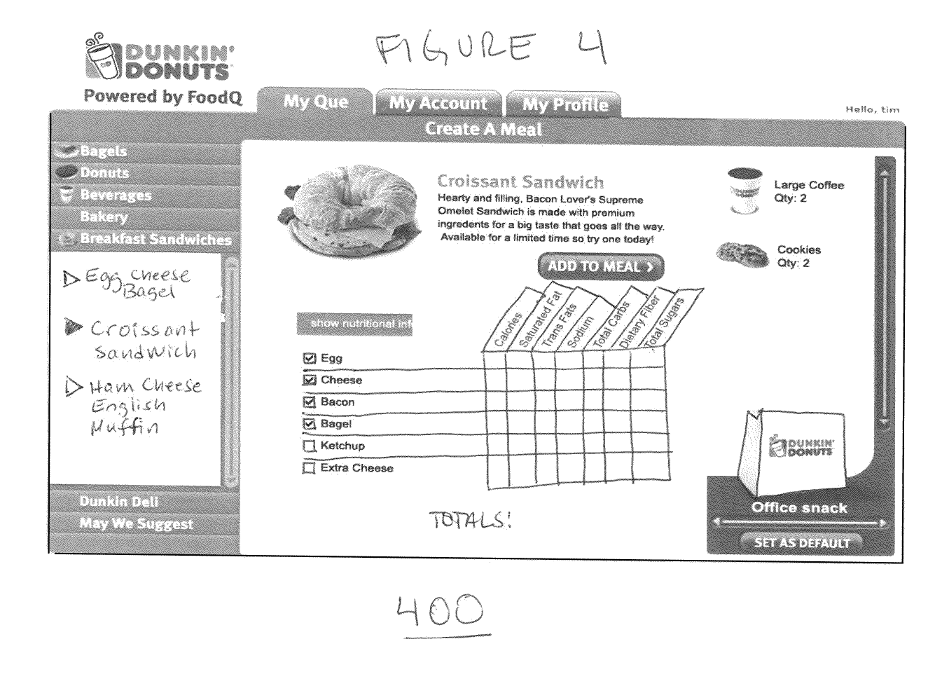

FIGS. 3 and 4 show examples of graphical user interfaces provided by the system application to the consumer. In FIG. 3, a consumer can see what meals have been created for specific days of the week and has the option to edit such meals. In FIG. 4, a consumer can create a specific meal from a specific establishment, for example a croissant breakfast sandwich from Dunkin'Donuts®. Once the food elements are selected, the consumer can choose to view the nutritional content of the meal, as shown in FIG. 4.

Although various embodiments which incorporate the teachings of the present invention have been shown and described in detail herein, those skilled in the art can readily devise many other varied embodiments that still incorporate these teachings.

I claim:

1. A system for automatically generating a food order for a consumer comprises:
a database comprising at least one consumer account;
a software application communicatively connected to the database and to an electronic device at a food establishment, wherein the software application comprises modules for completing the following steps:
creating the at least one consumer account using data entered by the consumer and the food establishment;
receiving data from the food establishment for identifying the consumer;
accessing the at least one consumer account;
generating a food order based on the account data;
transmitting the food order to the food establishment;
preparing the food order; and
delivering the food order to the consumer.
